(19) United States
(12) Patent Application Publication
(10) Pub. No.: US 2025/0181899 A1
(43) Pub. Date: Jun. 5, 2025

(54) VECTOR EMBEDDING PREPROCESSING AND RETRIEVAL FOR GENERATIVE MODELS

(71) Applicant: INTUIT INC., Mountain View, CA (US)

(72) Inventors: Rakesh AJMERA, Chelmsford, MA (US); Laurent BENCHIMOL, Cardiff by the Sea, CA (US); Shwetha Kalyanathaya SHASHIDHARA, Bengaluru (IN); Bhargavan MUTHUSELVAN, San Diego, CA (US); Rama PALANIAPPAN, San Diego, CA (US)

(21) Appl. No.: 18/525,225

(22) Filed: Nov. 30, 2023

(51) Int. Cl. G06N 3/0475

(52) U.S. Cl. CPC G06N 3/0475

(57) ABSTRACT

Certain aspects of the present disclosure provide techniques for preprocessing data prior to generating vector representations. The data is preprocessed to generate one or more natural language texts describing entities and relationships included in the data. Vector representations of the natural language format texts are stored in a vector database. The embeddings may be retrieved to augment a prompt for a generative model. The embeddings may be selected by performing a search of the vector database using an embedding for the prompt to determine relevant or similar embeddings. The augmented prompt can be input into a large language model. Although the model may be unaware of the data from which the embeddings of the embedding database were generated, the augmented prompt may enable the model to use the data to improve breadth and depth of responses. The preprocessing of the data improves response results of the model.

### INTRODUCTION

Aspects of the present disclosure relate to preprocessing data, vectorising the preprocessed data, storing the preprocessed data vector embeddings in a vector store database, and selectively retrieving the embeddings to augment an input prompt for a generative model.

### BACKGROUND

Machine learning models continue to be applied in various contexts, including for natural language modeling. An increasing number of different versions of large language models have become publicly and commercially available. Many such large language models have been sufficiently pre-trained to have the ability to perform well in language comprehension and generation tasks, with some limitations.

Various types of generative models are trained to generate output based on inferences learned from input data. The largest models are those that have been trained using a great deal of data. However, training and maintaining such models is expensive and time-consuming and requires an enormous amount of data. Training and updating are generally both performed offline for large scale models. Therefore, publicly available models intrinsically will be unaware of certain types of data, such as recent data not available at the time of training, or private data not used in training. For certain queries, it may be impossible to acquire and input the requisite information as data into a pretrained model to achieve an accurate result. In cases, a model may ‘hallucinate’ and fabricate an inaccurate response or may fail to perform a requested task without the needed data. Oftentimes, the needed dataset for achieving accuracy is recent and/or private data, and is prohibitively large in size to be used as input when prompting a trained model for a response.

Accordingly, techniques are needed that enable such models to generate more meaningful responses with less hallucinations, and improved responsiveness, relevancy, and context, particularly for requested tasks related to recent or private information. Also, techniques are needed for providing information contained in relatively large datasets to a trained model for improved accuracy of results from the trained model.

### BRIEF SUMMARY

Certain embodiments provide a computer-implemented method for augmenting queries using vector embedding preprocessing and retrieval for language generation models, such as for generating responses to prompts using a machine learning model or large language model.

In various embodiments, methods disclosed herein comprise: receiving data including entities and relationships between entities; preprocessing the data to generate one or more natural language texts describing the entities and the relationships between entities included in the data; generating one or more embeddings for the one or more natural language texts; storing the one or more embeddings in a vector store; and generating an augmented prompt based on a received prompt and based on at least one embedding retrieved from the vector store by using an embedding for the received prompt to perform a search of the vector store.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 illustrates an example computing environment in which vector embedding preprocessing for generative models may be performed, according to various embodiments of the present disclosure.

FIG. 2 illustrates an example system architecture using vector embedding preprocessing for a generative language model, according to various embodiments of the present disclosure.

FIG. 3 illustrates an example workflow using vector embedding preprocessing and retrieval, according to various embodiments of the present disclosure.

FIG. 4 illustrates an example method of vector embedding preprocessing for a generative model, according to various embodiments of the present disclosure.

FIG. 5 illustrates an example system configured to generate results from a language model using vector embedding preprocessing, according to various embodiments of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Using vector embedding preprocessing as described herein, vector embeddings which have undergone preprocessing stages can be retrieved for generating augmented prompts that can be used as input for models to achieve better results. Prompts augmented in such a way can result in a more comprehensive and deeper understanding by the model. The additional context results in a broader range of answerable questions more detailed and/or more accurate results, with less “hallucinations” or inaccurate responses. In particular, information contained in recent or private data can be understood by the model and despite not being available as training data, so that a large language model can consider such information despite not having been trained using the information.

In some cases, the recent or private data may be considerably large and may take a large amount of memory. For example, storing transaction data for a large number of entities may be done using a dedicated relational database. It will be appreciated that databases can contain a great deal of information, such that advanced techniques are needed to improve the efficiency of generating vector embeddings for the data.

In a relational database, entities have a relationship to one another which may be described according to a type or label for the relationship. By first converting structured data from a relational database to a natural language format or document, based on the relationships and entities described by the structured data, improved results are achieved by using vector embeddings that are generated by embedding the natural language format document rather than the structured data.

Various types of “markup” languages can be used to generate sentences based on entities and relationships between entities. By way of example, Entity A may be a person, “Author A.” Entity B may be a thing “Book B,” Entity C may be another person “Person C”, A Relationship R1 may be “is an author of.” A Relationship R2 may be “is a favorite of.” In this example, Entity A wrote Book B, Entity A's favorite person is Entity C, and Entity C's favorite book is Book B. In general, this information may be stored in a relational database by including an entry in a cell of a database table or other type of entry to indicate R1 exists for Entity A to Entity B, R2 exists for Entity A to Entity C, and R2 exists for Entity C to Entity B. In general, any number of entities and relationships can be represented and stored in a relational database.

Continuing the example, rows (or columns) of such a database used to store entity and relationship information can be parsed to generate a series of markup documents. One example may be using “markdown language,” although other markup formats or lightweight summary formats may be used. Using markdown language, the data representing entities and relationships in such a relational database is converted to one or more natural language documents. These natural language documents may be chunked or further processed in some cases. The natural language documents or chunks are used to generate vector embeddings of the natural language of the document, which are then stored in a vector store or vector embedding database.

When the method is used in various examples, prompts received by a user or client device are augmented by using a similarity search of embeddings in the vector embedding database to retrieve embeddings that are relevant to the prompt, such as based on similarity between the embeddings and the prompt. This allows information to be retrieved and used as context. By preprocessing the data to generate natural language documents used for generating the embeddings, the retrieved embeddings are improved. As a result of the improved embedding retrieval, the prompts augmented using the retrieved embeddings provide improved context and generate better results more quickly and with less computational difficulty. Thus, techniques described herein provide a technical solution to the technical problem of using a generative model to answer questions that require information included in a database that is larger than can be used as input and/or for fine tuning of the model. For example, by using embeddings of a markdown document generated from structured data from a relational database to retrieve information relevant to a prompt, and augmenting the prompt with the relevant information prior to providing the prompt as input to a generative model, embodiments of the present disclosure allow the model to be used to produce more accurate results more quickly and efficiently than could otherwise be done using conventional techniques.

### Example Computing Environment for Retrieval Augmented Generation

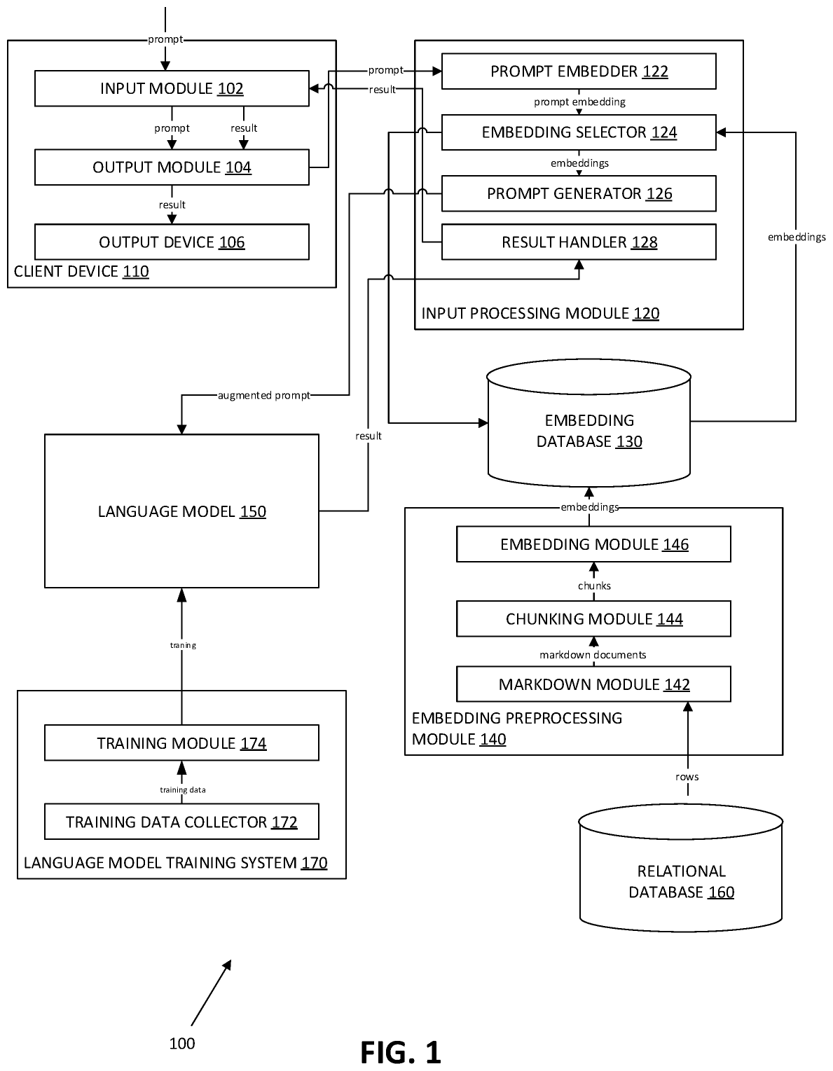

FIG. 1 illustrates an example computing environment 100 in which vector embedding preprocessing for generative models may be performed. As illustrated, computing environment 100 includes a client device 110 in communication with an input processing module 120.

As shown, the client device 110 includes an input module 102 and an output module 104. In the example shown, the input module accepts input, such as an input prompt from the user. The input prompt is then provided to the output module 104, and the input prompt is then passed to the input processing module 120 by the output module 104. The input may be received from a computing device or human user. The prompt in some cases can include a context. For example, the prompt may be received from a client device running an application on the client device. Various data and metadata associated with the application may be included in the prompt. The prompt may also include natural language input, such as a query entered by a user.

In FIG. 1, the input processing module 120 includes a prompt embedder 122, an embedding selector 124, a prompt generator 126, and a result handler 128. The prompt embedder 122 receives the prompt from the output module 104 of the client device 110. The prompt embedder 122 generates one or more embeddings for the prompt, such as by generating a vector representation of a query, data, and metadata associated with the prompt. Generation of embeddings may involve the use of an embedding model or other techniques.

The one or more embeddings are provided to the embedding selector 124, and the embedding selector 124 searches for and retrieves one or more stored embeddings from an embedding database 130, based on the one or more embeddings that were generated for the prompt. The stored embeddings can be selected based on a similarity to the one or more embeddings for the prompt. In various embodiments, different similarity algorithms, as well as other techniques for comparison, may be used for vector comparison.

In the example, the embedding database 130 includes embeddings that have been generated by an embedding preprocessing module 140. The embedding preprocessing module 140 includes a markdown module 142, a chunking module 144, and an embedding module 146.

The markdown module 142 receives data and converts the data to one or more markdown documents, or other markup format language documents. In this context, a markup language may be a template for conveying entities and relationships in a predictable or machine-readable way. In a particular example, the markdown module receives data in a relational database where rows and columns represent entities, and entries in a cell represent relationships between the entities associated with the index for the row and column for the cell. A row for a particular entity may be converted to markdown language, such that each relationship contained in the database table for the entity is stored in a markdown document.

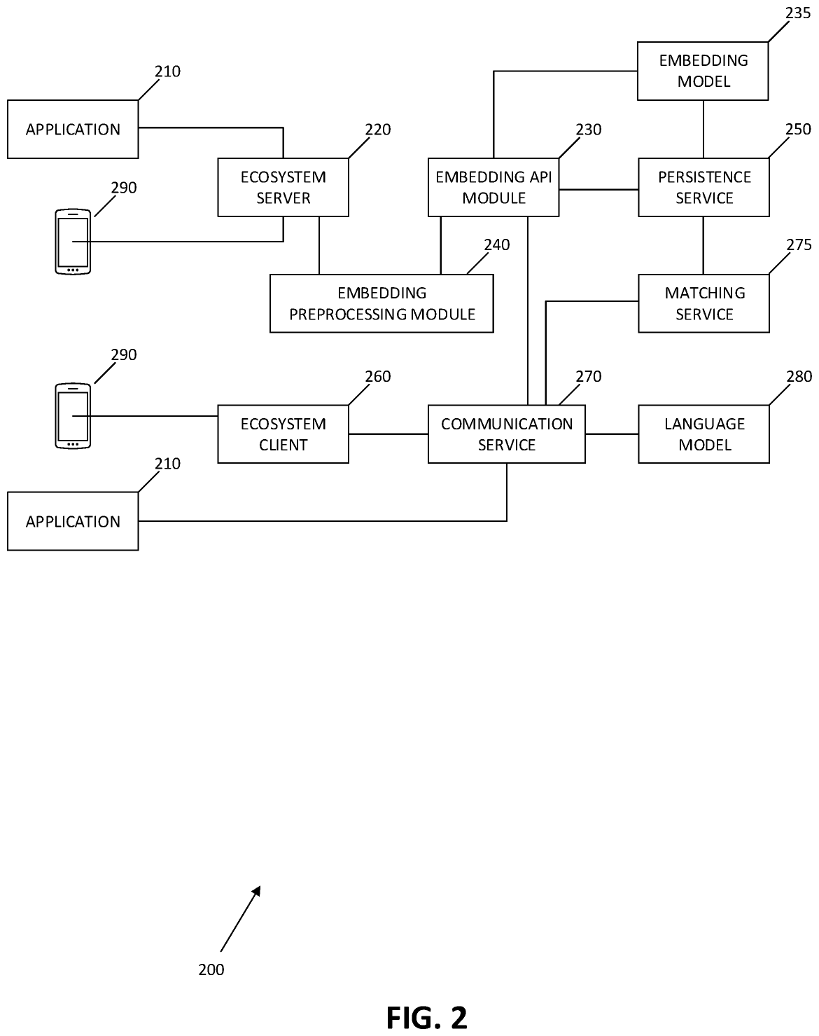

The chunking module 144 receives the markdown documents and divides or chunks the data into chunks. The chunked data is passed to the embedding module 146, which generates embeddings, which may be vector representations of the chunks, for the chunked data. The embedding module 146 may use an embedding model or other techniques, such as described in more detail below with respect to FIG. 2.

In the example shown, the embedding module 146 stores vector representations of the chunks of the markdown documents in the embedding database 130. In some embodiments, the documents and/or data may be associated with an application or suite of applications including an instance running on the client device from which the prompt is entered. Thus, data or metadata generated by or related to various applications belonging to a suite of applications can be chunked and embedded into the embedding database. Such data may be especially relevant to a particular prompt, but unknown to the user or model and/or unavailable using any public or non-recent data source. By generating embeddings based on markup documents and retrieving such embeddings from the embedding database 130, a prompt may be augmented to result in improved generation using a language model due to the particularly relevant data from which the stored embeddings are generated which was not previously available to the model.

In the example of FIG. 1, the prompt generator 126 receives the embeddings from the embedding selector 124 and generates an augmented prompt based on the input prompt and the stored embeddings that are retrieved by the embedding selector 126. The augmented prompt is then provided to a model, such as a generative language model, a generative image model, or other model using linguistic input. In certain embodiments, a domain specific language is used by the prompt embedder 122 and/or the embedding module 146. The domain specific language can be communicated via an application programming interface (API) by the embedding selector 124 to communicate specific selections of the embedding database 130.

In FIG. 1, the model 150 has been previously trained by a language model training system 170 including a training data collector 172 for collecting training data and a training module 174 which performs training of the model based on the data. For example, the training process by which model 150 was trained may be a supervised training process in which training inputs are provided as inputs to model 150, outputs are received from model 150 in response to the inputs, and parameters of model 150 are iteratively adjusted based on comparing the outputs to labels associated with the training inputs in the training data. In some embodiments, the language model 180 is a generative large language model. Such large language models can be expensive and time-consuming to train, and require a large amount of data. Fine-tuning may not be available or desirable in cases. However, using augmented prompts as described herein, an improved result can be generated using a generative large language model.

A result of the language model 150 may be received by the result handler 128. The result handler 128 can perform various actions based on the result. For example, the result may be sent to the client device 110, such as being received by the input module 102. The result may then be provided to the output module and output to a client, such as by being displayed on a monitor connected to the client device.

### Example System Architecture for Vector Embedding Preprocessing and Retrieval Using a Generative Model

FIG. 2 illustrates an example system architecture 200 for vector embedding preprocessing and retrieval using a generative model, according to various embodiments of the present disclosure.

As illustrated, the system architecture includes one or more applications 210, an ecosystem server 220, an embedding API 230, an embeddings model 235, an embedding preprocessing module 240, an internal persistence service 250, an ecosystem client 260, a communication service 270, a matching service 275, and a generative model, such as language model 280 or other generative model.

One or more user devices 290 may be connected to the system architecture or may interact with the system architecture by uploading documents to the ecosystem server 220 or by inputting a query or other prompt into the ecosystem client 260.

Documents and/or other data can be uploaded from a user device 290 or from one or more of the applications 210 to ecosystem server 220. The documents and/or other data uploaded to the server may then be processed by the embedding preprocessing module 240 prior to embeddings being generated for the documents and/or other data. In the example, the embedding preprocessing module 240 generates a set of one or more markup documents form the uploaded documents and/or other data. For example, a set of markdown documents can be generated for the uploaded documents and/or data, such as generating a markdown document for each uploaded document, or for data table rows of other uploaded data. In some embodiments, markdown documents can be generated from JavaScript object notation (“JSON”) data. The markdown documents may then be chunked into smaller chunks of the markdown documents.

In general, “Markdown language” or “Markdown” may refer to a type of lightweight markup language which is capable of describing entities and relationships in a plain-text document in code form according to a defined syntax. “Markdown language” as used herein refers to a syntax or syntaxes that may be used to describe entities and relationships between entities in using either a basic syntax and/or an extended syntax, with or without tables, fenced code blocks, or other structures. As used herein, “Markup language” refers to any text encoding system sufficient to determine where symbols are inserted to format a document. One well known example is the hypertext markup language (“HTML”). A “lightweight” markup language may refer to a markup language this is simplified, such as by not including formatting types such as use of italics or bold, color, size, position, etc. . . . These elements that do not describe entities and relationships of entities may be omitted from a lightweight markup language as opposed to a non-lightweight markup language. A lightweight markup language may also be known as a simple markup language or humane markup language. “Markdown” refers to a type of markup language which may be used to generate documents using a library or syntax to describe entities and relationships between entities. In various embodiments, entities and relationships can be determined from different data sources, such as database rows, JSON objects, or natural language documents. Although markdown language is described in several embodiments here, it is anticipated that other defined syntaxes may be used in some applications, and that features of the present invention are equally applicable for various other markup languages which may be used to describe entities and relationships contained in data.

Embeddings for the chunked documents and/or other data can be generated from the markdown documents by providing the markdown document to the embeddings model 235 via the embeddings API 230 and the ecosystem server 220. For example, embeddings model 235 may be a machine learning model that is trained to generate an n-dimensional vector representation of a set of input data. An embedding generally refers to a vector representation of an entity that represents the entity as a vector in n-dimensional space such that similar entities are represented by vectors that are close to one another in the n-dimensional space. Embeddings model 235 may be, for example, a neural network or other type of machine learning model that learns a representation (embedding) for an entity through a training process that trains the neural network based on a data set, such as a plurality of features of a plurality of entities. In one example, the embedding model comprises a Bidirectional Encoder Representations from Transformer (BERT) model, which involves the use of masked language modeling to determine embeddings. In other embodiments, the embedding model may involve embedding techniques such as Word2Vec and GloVe embeddings. These are included as examples, and other techniques for generating embeddings are possible.

The embeddings may then be provided to a database or persistence service 250 for storage. The persistence service 250 can be any type of suitable data storage solution. In a particular example, a Postgres database may be used to provide data access, searching, and persistence features.

The system architecture 200 can be used by a user device 290 or an application 210 to generate a response for an input prompt, such as a question, query, instruction or other input. For example, a user of a user device 290 may input a question into the device 290. The user device 290 may be in communication with the ecosystem client 260 such that the prompt is received by the client 260 from the user device 290. In response, the ecosystem client 260 provides the prompt to the communication service 270. In another use case, an application 210 may send a prompt to the communication service 270 directly.

In response to receiving a prompt, the communication service 270 makes an API call to the embeddings model 235 via the embeddings API module 230 to generate and receive one or more embeddings for the prompt. The one or more embeddings for the prompt are passed to the matching service 275, which determines the closest, most similar, or most relevant embeddings from those stored in the persistence service 250. Thus, information from documents which were uploaded by an application 210 or a user device 290 that are most relevant to the input prompt can be retrieved from the internal persistence service 250 by the matching service 275 by determining similar or otherwise relevant embeddings.

The embeddings retrieved from the persistence service 250 by the matching service 275 can be used by the communication service to augment the initial prompt input into the user device 290. In response to producing the augmented prompt, the communication service 270 uses the augmented prompt as input for the language model 280 to obtain a response from the model 280. The response from the large language model is more detailed, accurate, and complete as compared with a response generated without an augmented prompt. In other embodiments, a generative image, sound, or video model, or other type of generative model is used instead of the language model 280.

### Example Workflow Using Vector Embedding Preprocessing and Retrieval

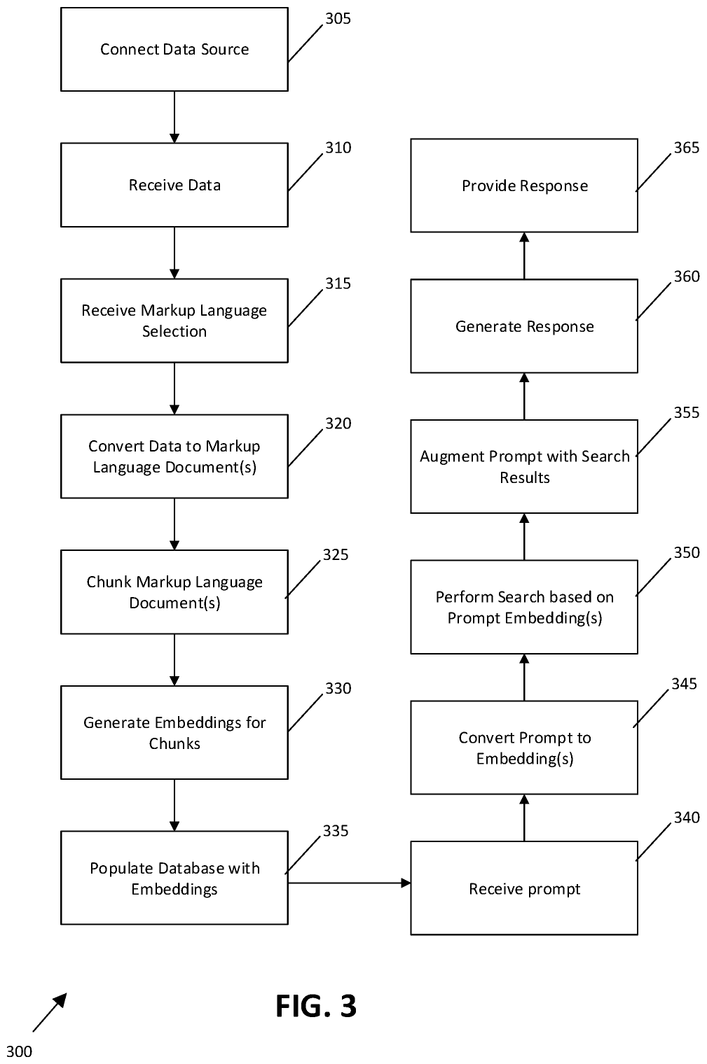

FIG. 3 illustrates an example workflow 300 using retrieval augmented generation, according to various embodiments of the present disclosure. The workflow 300 may be performed by a server or host computing device, which may be in communication with a user or client computing device via a networked connection.

In the example of FIG. 3, the workflow 300 begins at stage 305 where a data source is connected. In various embodiments, a data source may be identified by a client device and the identified data source may be connected, such as by opening a network connection or mounting a storage location of the data source. In other embodiments, data sources may be connected by an administrator of a server device, and a client device is used to access a server device hosting the workflow 300.

Next, the workflow proceeds to stage 310 where data is received from the data source. In various embodiments, data sources can have various different data types, objects, or data structures which may be received, such as rows of a relational database, a collection of JSON files, or other data.

The workflow may then proceed to stage 315 where a markup language is selected. For example, markdown language or another markup language for a particular data type may be selected. Next, the workflow 300 may proceed to stage 320 where data is converted to one or more markup language documents. For example, the data may be used to generate a natural language format representation of rows of a relational database, or to generate a natural language format representation of a JSON object or file. The natural language format representation is stored as a markup document, such as a markdown language document. In various embodiments, one or more export scripts may be run on the data to generate the natural language texts. In other embodiments, a template is used to generate the natural language texts by determining placement of entities, relationships, and connecting words in the natural language texts.

The workflow 300 may then proceed to stage 325 where the one or more markup language documents are chunked. For example, various types of delimiters may be defined to determine chunks of the markup language documents. Next, the workflow 300 proceeds to stage 330 where one or more embeddings are generated for the one or more chunks, for example using an embedding model such as BERT, Word2Vec, or GloVe.

The workflow 300 then proceeds to stage 335 where a database is populated with the embeddings. For example a Postgres database may suitable for provide persistence and searching capabilities and may store an arbitrarily large number of embeddings.

Next, workflow 300 may proceed to stage 340 where a prompt is received. For example, a user may input a query, prompt, or other input into a client device, and the prompt or other input may be received by a server device hosting the workflow. Next, the workflow 300 may proceed to stage 345 where the prompt is converted to one or more embeddings. For example, the embedding model used to generate the embeddings for the chunks of the markdown documents at stage 330 may also be used to generate embeddings for the prompt.

In some embodiments, the prompt may be preprocessed before an embedding for the prompt is generated. Preprocessing may include adding chat history and/or parsing a chat history of the user using one or more of tags, filters, or other search space limitations to determine suitable segments for embedding. Chat histories from a plurality of other users may also be added for relevant contextual information. Preprocessing may be used to determine a class of the prompt. For example, whether the prompt relates to a product question, or an account question, and one or more actions may be taken based on a preprocessing. Preprocessing may further use a local language model or an external model to generate a summary of the relevant contextual information, which may be included in or which may replace the prompt prior to generating an embedding of the prompt.

Next, the workflow 300 may proceed to stage 350 where a search is performed using the embedding for the prompt. For example, a search module of the server device may perform a search of the database populated with the embedded chunks at stage 335 to identify and retrieve embeddings that are relevant to or semantically similar to the embedding generated from the prompt.

The workflow 300 may then proceed to stage 355 where the prompt is augmented with the search results. In various embodiments, one or more embeddings may be retrieved from a database based on relevance or semantic similarity to an embedding for an input prompt. The embeddings may be used to augment the prompt, such as by being provided with the prompt as input, by being provided as a context for the input, and/or by being merged or concatenated with the input. For example, the prompt may be augmented by the server device by retrieving embeddings from the embedding database and adding content (e.g., text) corresponding to the retrieved embeddings to the prompt to generate an augmented prompt.

The workflow 300 may then proceed to stage 360 where a response to the prompt is generated. For example, an augmented prompt generated at stage 355 may be input into a model that has been previously trained to generate responses based on an input prompt and/or an input context. In some cases, the size of the augmented prompt can include a number of embeddings that is a maximum number of possible embeddings based on a maximum token count for input and/or input context for the model.

Next, the workflow may proceed to stage 360 where a response is generated. In various embodiments, a large language model is used to generate a response based on an augmented question (e.g., the augmented prompt). In other embodiments the augmented prompt may be used for image, video, or sound generation, or as input for another type of generative model. Once the response has been generated at stage 360, the workflow may proceed to stage 365 where a response may be provided to or accessed by a user or client device, and the workflow 300 may conclude.

### Example Method of Vector Embedding Preprocessing and Retrieval Using a Generative Model

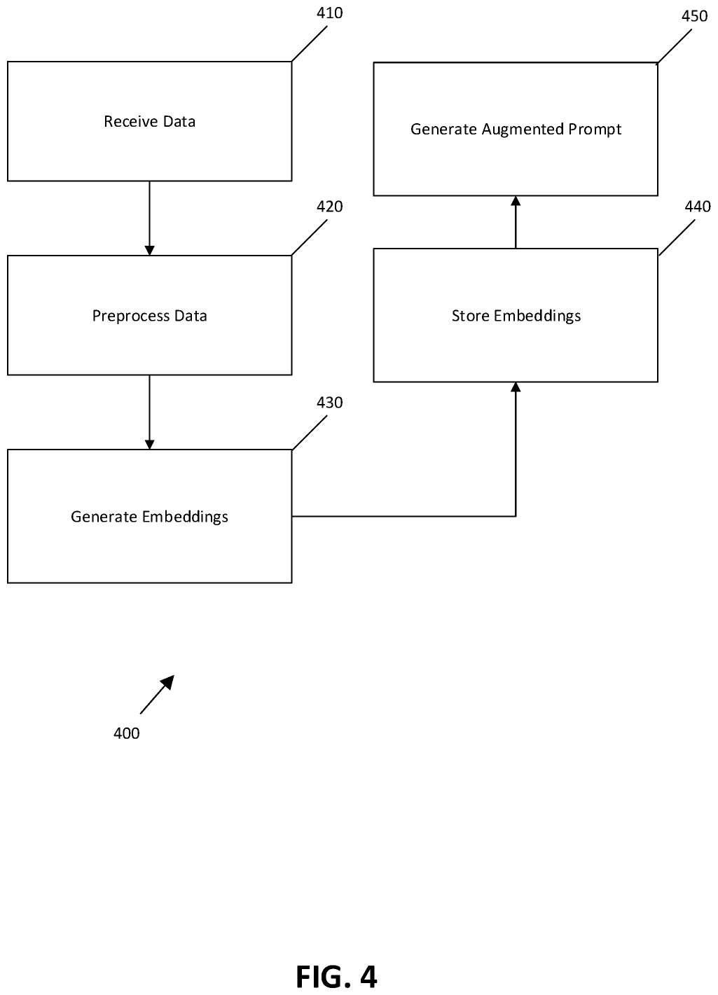

FIG. 4 illustrates an example method 400 of retrieval augmented generation, according to various embodiments of the present disclosure.

In FIG. 4, the method 400 begins at stage 410 where data is received. For example, a corpus of data including a variety of documents of different types may be received by a server device. The corpus of data may include entities and relationships between entities. The entities and relationships between entities may be contained in the data in a non-natural language format.

Next, the method 400 proceeds to stage 420 where the data is preprocessed. For example, the data may be used to generate one or more natural language texts describing the entities and relationships between entities included in the data. In various embodiments, the natural language texts may be generated by executing an export script on the data or by applying a template to the data.

The method 400 may then proceed to stage 430 where embeddings are generated. Various embedding techniques may be used to generate one or more embeddings from the natural language texts. In some embodiments, a natural language text may be generated for each row of a relational database, and the natural language may each be used to generate an embedding. In some embodiments, rows of the relational database may represent entities contained in the data.

The natural language texts in some embodiments may be chunked. Chunking the data enables embeddings to be generated separately for various units or chunks of data. In various embodiments, the units of data may be defined according to different delimiters, which may be algorithmic and/or configurable according to one or more classifications of data. In a particular example, data chunks are defined that represent one or more objects or object classes or types associated with a particular software application and/or account.

In various embodiments, embeddings are generated for the chunks. For example, a vector representation may be used as a numerical representation of a chunk of data, and the chunks may be each embedded into a vector representation for improved searching and processing. In some embodiments, an embedding API can be used, such as Azure OpenAI embeddings API. In some embodiments, a private language model is be used to convert text or chunks into embeddings, which may be hosted in a location accessible to a user endpoint.

Next, the method 400 may proceed to stage 440 where the embeddings are stored. For example, a server device may store the embeddings in a vector database or vector store having searching and persistence features. Storing the embeddings in a vector database may enable advanced searching and relational matching, such as provided, for example, by OpenSearch.

The method 400 may then proceed to stage 450 where an augmented prompt is generated. For example, an augmented prompt may be generated based on a prompt received by a server device and based on at least one embedding retrieved from the vector store by the server device using an embedding for the received prompt to perform a search of the vector store to determine the at least one embedding.

Once the augmented prompt is generated, the augmented prompt may be used as input into a generative model, or otherwise provided to a user or endpoint, and the method 300 may conclude. In some embodiments, after the augmented prompt is provided to a model by the server device and a response is received from the model, the response from the model may be displayed or otherwise output on a client device that is used to access a server device performing the method.

### Example System Using Vector Embedding Preprocessing and Retrieval

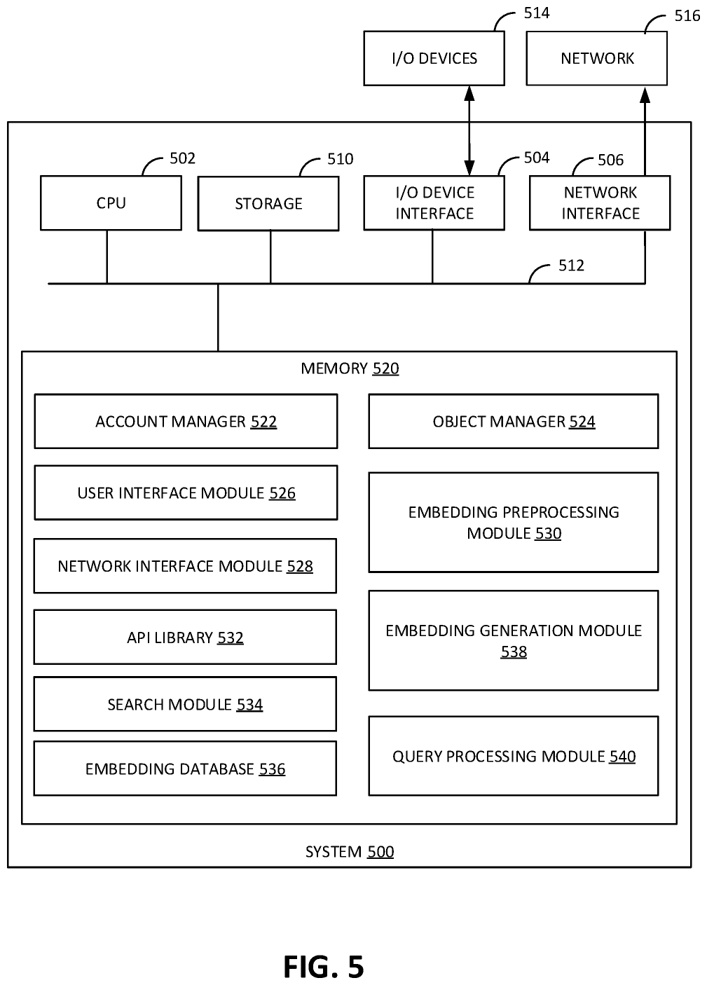

FIG. 5 illustrates an example system 500 configured to perform the methods described herein, including, for example, method 400 of FIG. 4. In some embodiments, system 500 may act as a prompt augmenter or input preprocessor, such as the input processing module 140 of FIG. 1.

As shown, system 500 includes a central processing unit (“CPU”) 502, one or more I/O device interfaces 504 that may allow for the connection of various input and/or output (“I/O”) devices 514 (e.g., keyboards, displays, mouse devices, pen input, etc.) to the system 500, network interface 506 through which system 500 is connected to network 516 (which may be a local network, an intranet, the internet, or any other group of computing devices communicatively connected to each other), a memory 520, storage 510, and an interconnect 512. In embodiments, the I/O devices 514 and/or network interface 506 may be used to receive a query in a natural language utterance through a chatbot application and output a response to the query generated based on extracting operators and operands from the natural language utterance.

CPU 502 may retrieve and execute programming instructions stored in the memory 520 and/or storage 510. Similarly, the CPU 502 may retrieve and store application data residing in the memory 520 and/or storage 510. The interconnect 512 transmits programming instructions and application data, among the CPU 502, I/O device interface 504, network interface 506, memory 520, and/or storage 510. CPU 502 is included to be representative of a single CPU, multiple CPUs, a single CPU having multiple processing cores, and the like.

Memory 520 is representative of a volatile memory, such as a random access memory, or a nonvolatile memory, such as nonvolatile random access memory, phase change random access memory, or the like. As shown, memory 520 includes an account manager 522, an object manager 524, a user interface module 526, a query processing module 530, an application programming interface (“API”) library 532, a search module 534, an embedding database 536, an embedding preprocessing module 538, and a query processing module 540.

The account manager 522 may be used to manage information associated with particular users of the system 500. For example, the account manager may be used to authenticate a user or provide user profile information. The object manager 524 may be used to manage objects, such as generating or storing chat histories, accounts, or other data objects associated with or used by the system 500. In various embodiments, a user interface module 526 is included to prepare data for output to one or more of the I/O devices 514 via the I/O interface 504. Network interface module 528 may similarly prepare data for output to one or more locations on the network 516 via the network interface 506.

The embedding preprocessing module 530 receives and processes data into one or more natural language documents. For example, data contained in a relational database can be rewritten in natural language form according to a markup language or template, such as markdown format. Other structured data may also be rewritten in natural language form according to a template or

The embedding generation module 538 receives documents, data, or chunks and generates embeddings for the chunks. The embedding generation module 538 may embed chunks of markdown documents generated from, for example, rows of a relational database or other structured data into a vector representation. Also, the embedding generation module 538 may generate embeddings for a query or prompt input by a user or otherwise received from the query processing module 540. The query processing module 540 may utilizer the embedding generation module 538 to generate embeddings for input queries.

The query processing module 540 may use the API library 532 to generate an API call using a domain specific (or other) language. The search module 534 may be used to execute search requests on the embedding database 536 by making an API call to retrieve relevant embeddings using, for example, a similarity search or semantic similarity search that compares one or more embeddings of a prompt to embeddings in the embedding database to determine the relevant embeddings. The search module may also use tags, labels, filters, or other techniques to specify a selection of embeddings from which a relevant embedding may be retrieved. In this way, an input query may be received by the system, processed by the query processing module 540 using the embedding generation module 538 to generate an embedding for the query. The search module may identify and/or retrieve one or more embeddings from the embedding database 536. The data source for these embeddings will have been preprocessed by the embedding preprocessing module 530 to result in chunks of markdown documents which are converted to embeddings by the embedding generation module 538. The embeddings received by the search module 534 may be used by the query processing module 540 to generate an augmented query, which may output via an I/O device 514 or network 516, such as to a generative model (i.e. a large language model) for generating a response to the augmented query.

### Example Clauses

Aspect 1: A method, comprising: receiving data including entities and relationships between entities; preprocessing the data to generate one or more natural language texts describing the entities and the relationships between entities included in the data; generating one or more embeddings for the one or more natural language texts; storing the one or more embeddings in a vector store; and generating an augmented prompt based on a received prompt and based on at least one embedding retrieved from the vector store by using an embedding for the received prompt to perform a search of the vector store.

Aspect 2: The method of Aspect 1, comprising providing the augmented prompt to a large language model; receiving an output from the large language model in response to the augmented prompt; and providing a response to the augmented prompt based on the output.

Aspect 3: The method of any of Aspects 1-2, wherein: receiving the data comprises connecting a database and executing an export script on the database; executing the export script comprises using a template to generate natural language format data from data contained in the database; and generating one or more natural language texts based on the data comprises generating natural language text from the natural language format data.

Aspect 4: The method of any of Aspects 1-3, wherein the database includes one or more rows of structured data, and the one or more natural language texts comprise one or more markdown documents respectively generated for the one or more rows of structured data.

Aspect 5: The method of any of Aspects 1-4, wherein the database is a relational database and executing the export script on the database comprises using the template to determine natural language descriptions of relationships between entities in the database and generate the natural language format data.

Aspect 6: The method of any of Aspects 1-5, further comprising: chunking the one or more natural language texts to produce a plurality of data chunks; generating a plurality of embeddings for the plurality of data chunks; and storing the plurality of embeddings for the plurality of data chunks in the vector store.

Aspect 7: The method of any of Aspects 1-6, wherein the one or more natural language texts are chunked using a configurable algorithmic delimiter.

Aspect 8: The method of any of Aspects 1-7, further comprising: preprocessing the received prompt by performing summarization on the received prompt; performing entity extraction on the received prompt; and performing classification on the received prompt; and retrieving the embedding from the vector store based on a result of the preprocessing of the received prompt.

Aspect 9: The method of any of Aspects 1-8, wherein retrieving the at least one embedding from the vector store comprises: performing a semantic search using a similarity algorithm and the embedding for the received prompt to identify one or more similar embeddings in the vector store, the one or more similar embeddings being similar to the embedding for the received prompt; and combining the one or more similar embeddings and the embedding for the received prompt to create the augmented prompt.

Aspect 10: A system comprising: a memory having executable instructions stored thereon; an endpoint having a user interface; and one or more processors configured to execute the executable instructions to cause the system to perform a method comprising: receiving data including entities and relationships between entities; preprocessing the data to generate one or more natural language texts describing the entities and the relationships between entities included in the data; generating one or more embeddings for the one or more natural language texts; storing the one or more embeddings in a vector store; and generating an augmented prompt based on a received prompt and based on at least one embedding retrieved from the vector store by using an embedding for the received prompt to perform a search of the vector store.

Aspect 11: The system of Aspect 10, wherein the method further comprises: providing the augmented prompt to a large language model; receiving an output from the large language model in response to the augmented prompt; and providing a response to the augmented prompt based on the output.

Aspect 12: The system of any of Aspects 10-11, wherein: receiving the data comprises connecting a database and executing an export script on the database; executing the export script comprises using a template to generate natural language format data from data contained in the database; and generating one or more natural language texts based on the data comprises generating natural language text from the natural language format data.

Aspect 13: The system of any of Aspects 10-12, wherein the database includes one or more rows of structured data, and the one or more natural language texts comprise one or more markdown documents respectively generated for the one or more rows of structured data.

Aspect 14: The system of any of Aspects 10-13, wherein the database is a relational database and executing the export script on the database comprises using the template to determine natural language descriptions of relationships between entities in the database and generate the natural language format data.

Aspect 15: The system of any of Aspects 10-14, wherein the method further comprises: chunking the one or more natural language texts to produce a plurality of data chunks; generating a plurality of embeddings for the plurality of data chunks; and storing the plurality of embeddings for the plurality of data chunks in the vector store.

Aspect 16: The system of any of Aspects 10-15, wherein the one or more natural language texts are chunked using a configurable algorithmic delimiter.

Aspect 17: The system of any of Aspects 10-16, wherein the method further comprises: preprocessing the received prompt by performing summarization on the received prompt; performing entity extraction on the received prompt; and performing classification on the received prompt; and retrieving the embedding from the vector store based on a result of the preprocessing of the received prompt.

Aspect 18: The system of any of Aspects 10-17, wherein retrieving the at least one embedding from the vector store comprises: performing a semantic search using a similarity algorithm and the embedding for the received prompt to identify one or more similar embeddings in the vector store, the one or more similar embeddings being similar to the embedding for the received prompt; and combining the one or more similar embeddings and the embedding for the received prompt to create the augmented prompt.

Aspect 19: A non-transitory computer readable storage medium comprising instructions, that when executed by one or more processors of a computing system, cause the computing system to perform a method comprising: receiving data including entities and relationships between entities; preprocessing the data to generate one or more natural language texts describing the entities and the relationships between entities included in the data; generating one or more embeddings for the one or more natural language texts; storing the one or more embeddings in a vector store; and generating an augmented prompt based on a received prompt and based on at least one embedding retrieved from the vector store by using an embedding for the received prompt to perform a search of the vector store.

Aspect 20: The non-transitory computer readable storage medium of Aspect 19, wherein the method further comprises: providing the augmented prompt to a large language model; receiving an output from the large language model in response to the augmented prompt; and providing a response to the augmented prompt based on the output.

### Additional Considerations

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
receiving data including entities and relationships between entities;
preprocessing the data to generate one or more natural language texts describing the entities and the relationships between entities included in the data;
generating one or more embeddings for the one or more natural language texts;
storing the one or more embeddings in a vector store; and
generating an augmented prompt based on a received prompt and based on at least one embedding retrieved from the vector store by using an embedding for the received prompt to perform a search of the vector store.

2. The method of claim 1, comprising
providing the augmented prompt to a large language model;
receiving an output from the large language model in response to the augmented prompt; and
providing a response to the augmented prompt based on the output.

3. The method of claim 1, wherein:
receiving the data comprises connecting a database and executing an export script on the database;
executing the export script comprises using a template to generate natural language format data from data contained in the database; and
generating one or more natural language texts based on the data comprises generating natural language text from the natural language format data.

4. The method of claim 3, wherein the database includes one or more rows of structured data, and the one or more natural language texts comprise one or more markdown documents respectively generated for the one or more rows of structured data.

5. The method of claim 3, wherein the database is a relational database and executing the export script on the database comprises using the template to determine natural language descriptions of relationships between entities in the database and generate the natural language format data.

6. The method of claim 1, further comprising:
chunking the one or more natural language texts to produce a plurality of data chunks;
generating a plurality of embeddings for the plurality of data chunks; and
storing the plurality of embeddings for the plurality of data chunks in the vector store.

7. The method of claim 6, wherein the one or more natural language texts are chunked using a configurable algorithmic delimiter.

8. The method of claim 1, further comprising:
preprocessing the received prompt by
performing summarization on the received prompt;
performing entity extraction on the received prompt; and
performing classification on the received prompt; and
retrieving the embedding from the vector store based on a result of the preprocessing of the received prompt.

9. The method of claim 1, wherein retrieving the at least one embedding from the vector store comprises:
performing a semantic search using a similarity algorithm and the embedding for the received prompt to identify one or more similar embeddings in the vector store, the one or more similar embeddings being similar to the embedding for the received prompt; and
combining the one or more similar embeddings and the embedding for the received prompt to create the augmented prompt.

10. A system comprising:
a memory having executable instructions stored thereon;
an endpoint having a user interface; and
one or more processors configured to execute the executable instructions to cause the system to perform a method comprising:
receiving data including entities and relationships between entities;
preprocessing the data to generate one or more natural language texts describing the entities and the relationships between entities included in the data;
generating one or more embeddings for the one or more natural language texts;
storing the one or more embeddings in a vector store; and
generating an augmented prompt based on a received prompt and based on at least one embedding retrieved from the vector store by using an embedding for the received prompt to perform a search of the vector store.

11. The system of claim 10, wherein the method further comprises:
providing the augmented prompt to a large language model;
receiving an output from the large language model in response to the augmented prompt; and
providing a response to the augmented prompt based on the output.

12. The system of claim 10, wherein:
receiving the data comprises connecting a database and executing an export script on the database;
executing the export script comprises using a template to generate natural language format data from data contained in the database; and
generating one or more natural language texts based on the data comprises generating natural language text from the natural language format data.

13. The system of claim 12, wherein the database includes one or more rows of structured data, and the one or more natural language texts comprise one or more markdown documents respectively generated for the one or more rows of structured data.

14. The system of claim 12, wherein the database is a relational database and executing the export script on the database comprises using the template to determine natural language descriptions of relationships between entities in the database and generate the natural language format data.

15. The system of claim 10, wherein the method further comprises:
chunking the one or more natural language texts to produce a plurality of data chunks;
generating a plurality of embeddings for the plurality of data chunks; and
storing the plurality of embeddings for the plurality of data chunks in the vector store.

16. The system of claim 15, wherein the one or more natural language texts are chunked using a configurable algorithmic delimiter.

17. The system of claim 10, wherein the method further comprises:
preprocessing the received prompt by
performing summarization on the received prompt;
performing entity extraction on the received prompt; and
performing classification on the received prompt; and
retrieving the embedding from the vector store based on a result of the preprocessing of the received prompt.

18. The system of claim 10, wherein retrieving the at least one embedding from the vector store comprises:
performing a semantic search using a similarity algorithm and the embedding for the received prompt to identify one or more similar embeddings in the vector store, the one or more similar embeddings being similar to the embedding for the received prompt; and
combining the one or more similar embeddings and the embedding for the received prompt to create the augmented prompt.

19. A non-transitory computer readable storage medium comprising instructions, that when executed by one or more processors of a computing system, cause the computing system to perform a method comprising:
receiving data including entities and relationships between entities;
preprocessing the data to generate one or more natural language texts describing the entities and the relationships between entities included in the data;
generating one or more embeddings for the one or more natural language texts;
storing the one or more embeddings in a vector store; and
generating an augmented prompt based on a received prompt and based on at least one embedding retrieved from the vector store by using an embedding for the received prompt to perform a search of the vector store.

20. The non-transitory computer readable storage medium of claim 19, wherein the method further comprises:
providing the augmented prompt to a large language model;
receiving an output from the large language model in response to the augmented prompt; and
providing a response to the augmented prompt based on the output.
